(19) United States
(12) Patent Application Publication
(10) Pub. No.: US 2003/0098891 A1
(43) Pub. Date: May 29, 2003

(54) System and method for multifunction menu objects

(75) Inventor: Mark E. Molander, Cary, NC (US)

Correspondence Address: Gerald R. Woods, IBM Corporation, T81/503, PO Box 12195, Research Triangle Park, NC, 27709, US

(73) Assignee: International Business Machines Corporation, Armonk, NY (US)

(21) Appl. No.: 09/845,537

(22) Filed: Apr. 30, 2001

(51) Int. Cl. G06F 3/00

(52) U.S. Cl. 345/841

(57) ABSTRACT

System and Method for Multifunction Menu Objects A system and method for providing multiple functions from a menu item is provided. A menu item is configurable to include graphical components, such as icons, that can be selected by a user to launch specific functions. In a word processing example, a word processing menu item, such as a menu item displayed from a “start programs” menu, can include icons corresponding to functions such as search for documents and list recently edited documents directly from the menu item. Another icon is used to display functions in a sub-menu that is displayed to the user. Menu items can be configured to include both functions that are invoked directly from the menu item as well as a sub-menu that can include additional functions. A configuration tool is provided to allow the user to customize a menu item by including certain functions on the menu item and certain functions in a sub-menu.

### BACKGROUND OF THE INVENTION

1. Technical Field

The present invention relates in general to a method and system for menu controls on a computer system. More particularly, the present invention relates to a system and method for providing multiple user-selectable functions from an individual menu item.

2. Description of the Related Art

Modern computer systems often provide graphical user interfaces (“GUIs”) to enable users to more easily operate the computer and to present information to the user in a way that is easier to understand. In addition, graphical user interfaces allow users to use the computer without having to learn and remember commands that, in non-GUI systems, are entered at a command prompt.

Graphical user interfaces are included with a number of operating systems including IBM's OS/2™ Operating System, Microsoft's “Windows” based operating systems (such as Windows NT™, Windows 95™, Windows 98™, and Windows 2000™) as well as the Apple Computer Corporation's operating systems for the Apple Macintosh™ computer system. The graphical user interface is typically a software program, or set of programs, that sit as a layer above the operating system itself. The core operating system functions, the management of the computer system, lie in the kernel of the operating system. The display manager is typically separate from the kernel, though it may be tied tightly to the kernel beneath. The ties between the operating system kernel and the user interface, utilities and other software define many of the differences in operating systems today, and will likely further define them in the future.

Graphical user interfaces often use a container, called a “window,” to present contents of a particular application. In this manner, a spreadsheet program and a word processing program can both be displayed on the computer display simultaneously and the user can easily distinguish between the open applications. The user uses the keyboard or, more commonly, a pointing device such as a mouse, trackball, or graphics tablet, to select GUI components and to select a particular window. Selecting an application in a particular window causes the selected window and application to become the “active window.”Keyboard and pointing device commands are directed towards the active window until another window is selected.

Within a window typically lie many GUI components such as frames, command buttons, controls, and bar UIs such as title bar, status bar, and menu bar. The menu bar gives access to a series of menu pull downs. Menus can also be provided in a “start menu” provided from the desktop area of the main GUI display. Contextual menus are also available via methods such as right clicking a GUI element. Menus allow the user to select menu items which launch applications or functions and also allow the user to traverse to lower layers of menus. Because menus are often layered, they can provide a great deal of command and functions and can be several layers deep.

Items that appear when a menu is opened are called “menu items.” Menu items typically provide one of three functions. First, a menu item may correspond with an application or function so that when the menu item is selected the corresponding application or function is launched. Second, a menu item may correspond to a setting, such as for instance a check box or radio button, so the user can directly make settings via a menu item without having to launch a new window. Third, a menu item may be a container for more menu items—when this type of menu item is selected the sub-menu with more menu items is displayed. Sub-menus can, in turn, include menu items that correspond to applications or functions as well as menu items that correspond to further sub-menus. Menu items that correspond to another sub-menu are often visually identified with a marker, such as a right arrow pointer, indicating that further menu items will be displayed if the menu item is displayed.

A challenge with graphical menus, as described above, is that many layers of menus and sub-menus may need to be selected before the user reaches the application or function that the user wants to execute. For example, if the user wants to execute the “search documents” function corresponding to a word processing application, the user selects a “start menu” item, then selects a “program” menu item that displays more menu items. Within the program menu item, the user may select an “office” menu item which displays a sub-menu of office applications such as word processors and spreadsheets. The user then selects on the word processing application and is presented with another sub-menu that includes functions within the word processor, one of which is the “search for documents” function. The user then selects the menu item corresponding to the “search for documents” function to execute the desired word processing function. As can be seen, several steps were needed to be taken by the user to invoke a relatively simple function. In addition, users are presented with “information overload” when presented with an increasing number of menu items and sub-menus making it more challenging for the user to identify and launch a desired application or function.

What is needed, therefore, is a way of providing multiple functions from within a particular menu item so that the user can more quickly execute the desired function. In addition, it would be desirable to allow the user to configure menu items to include functions that are more frequently used.

### SUMMARY

It has been discovered that more than one option can be provided on an individual menu item. An application can correspond with one part of the menu item and, for example, a sub-menu can correspond with another part of the menu item. When the application-portion of the menu item is selected the corresponding application is launched. Likewise, when the sub-menu portion of the menu item is selected the corresponding sub-menu is launched.

In addition, a menu item configuration function is provided to allow the user to configure additional functions that can be displayed in a sub-menu as well as allowing the user to place icons corresponding to frequently used functions directly on the menu item.

When a menu item has been configured, the user can select a portion of the menu item, such as a right pointing arrow, corresponding to a sub-menu and the configured submenu functions appear on the sub-menu. Items within the sub-menu can, in turn, be configured to allow sub-menus and sub-functions to be included with any particular menu item. When the user selects an icon corresponding to a frequently used function that appears on the menu item, the corresponding function or application is launched. In addition, when the application is selected, often the left side of the menu item which typically includes an icon corresponding to the menu item, then the application is launched without the user needing to navigate to a lower sub-menu.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 is an example of a menu that includes menu items with multiple functions per menu item;

FIG. 2 is a diagram showing how various components, or areas, within a menu item correspond to different functions or applications;

FIG. 3 is a diagram showing how various sub-menu items correspond to different functions or applications;

FIG. 4 is a user interface screen showing a configuration tool used to configure a given menu item;

FIG. 5 is a flowchart for configuring a menu item;

FIG. 6 is a flowchart for handling a user selection of a menu item component; and

FIG. 7 is a block diagram of an information handling system capable of implementing the present invention.

### DETAILED DESCRIPTION

The following is intended to provide a detailed description of an example of the invention and should not be taken to be limiting of the invention itself. Rather, any number of variations may fall within the scope of the invention which is defined in the claims following the description.

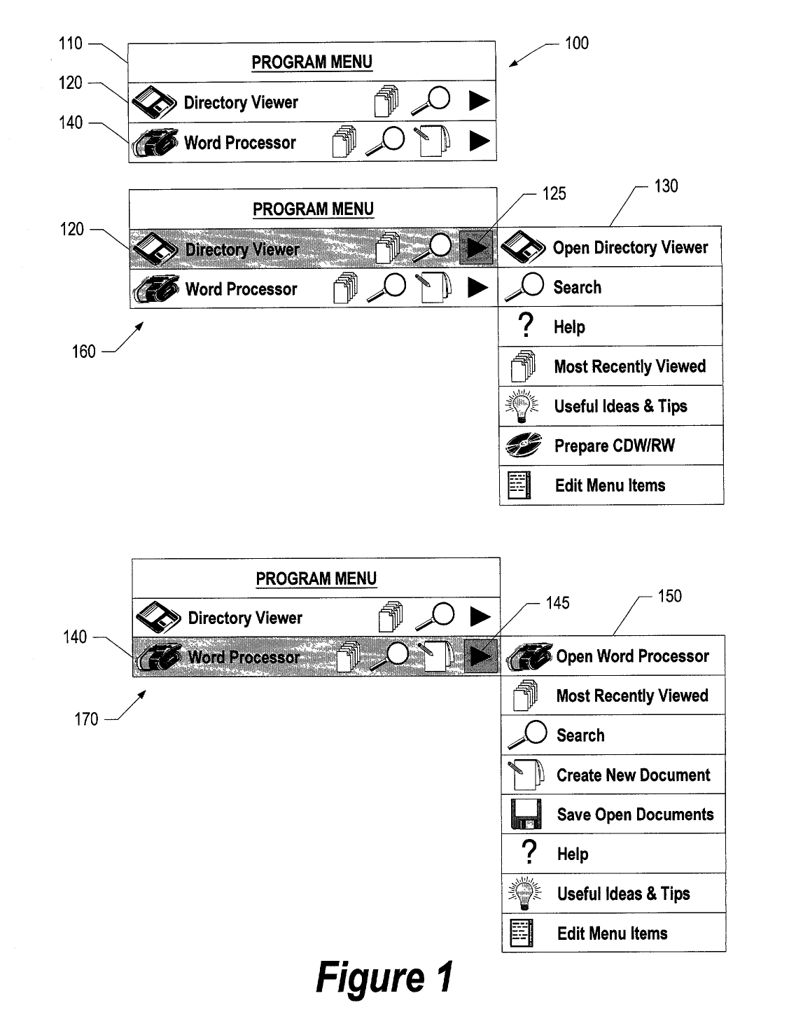

FIG. 1 is an example of a menu that includes menu items with multiple functions per menu item. Instance 100 shows program menu 110 with two menu items: directory viewer 120 and word processor 140. Each menu item is shown with various icons. Directory viewer 120 has a disk icon on the left side of the menu item and a sub-menu icon (right pointing arrow) on the right side of the menu item. In between these icons are two frequently used menu items a multi-page icon corresponding to a most recently viewed list and a magnifying glass icon corresponding to a disk search function. Word processor 140 has a document icon on the left side of the menu item and a sub-menu icon on the right side of the menu item. In between these icons are three frequently used menu items—a multi-page icon corresponding to a most recently viewed list, a magnifying glass icon corresponding to a document search function, and blank paper icon corresponding to a create new document function.

Instance 160 shows what happens when sub-menu icon 125 is selected within directory viewer menu item 120. Directory viewer menu item 120 is highlighted showing that it has been selected. In particular, the user selected the sub-menu display function as shown by the visible sub-menu and the additional highlighting for 125. Directory viewer sub-menu 130 is displayed showing various functions available within the directory view. When the sub-menu is opened, the user can select any of the sub-menu items to launch the corresponding program or function. In addition, any of the sub-menu items can be configured to also include sub-menus and frequently used icons. For example, the “help” sub-menu item could be configured to include a right arrow to open various help functions, and an “index” icon on the help menu item to launch the help index function when the icon is selected.

Instance 170 shows what happens when sub-menu icon 145 is selected within word processor menu item 140. Word processor menu item 140 is highlighted showing that it has been selected. In particular, the user selected the submenu display function as shown by the visible sub-menu. Word processor sub-menu 150 is displayed showing various functions available within the word processor. When the sub-menu is opened, the user can select any of the sub-menu items to launch the corresponding program or function. In addition, any of the sub-menu items can be configured to also include sub-menus and frequently used icons as described for the directory viewer above.

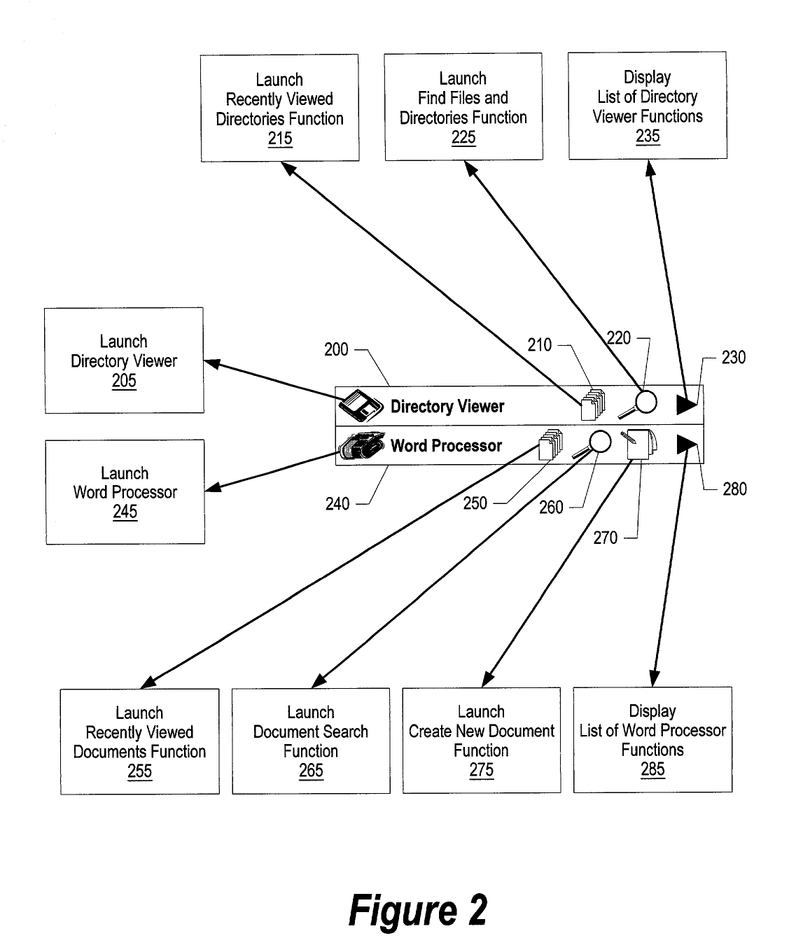

FIG. 2 is a diagram showing how various components, or areas, within a menu item correspond to different functions or applications. Directory viewer menu item 200 includes a disk icon and a label to inform the user that the menu item is for directory viewer functions. If the left side of menu item 200 is selected (left of icon 210), then the system launches the directory viewer (step 205). In addition, directory viewer menu item 200 includes three additional icons to quickly launch a particular function or application. When the recently viewed icon 210 is selected, the system launches a recently viewed directories function (step 215). Likewise, when the find files and directories icon 220 is selected, the system launches a find files and directories function (step 225). Finally, when the right-arrow sub-menu icon 230 is selected a function is launched by the system displaying a list of the available directory viewer functions (step 235) and allowing the user to select and launch one of the functions.

Word processor menu item 240 includes a document icon and a label to inform the user that the menu item is for word processor functions. If the left side of menu item 240 is selected (left of icon 250), then the system launches the Word processor (step 245). In addition, word processor menu item 240 includes four additional icons to quickly launch a particular function or application. When the recently viewed icon 250 is selected, the system launches a recently viewed documents function (step 255). Likewise, when the find documents icon 260 is selected, the system launches a find documents function (step 265). Again, when the new document icon 270 is selected, the system launches a create new document function (step 275). Finally, when the right-arrow sub-menu icon 280 is selected a function is launched by the system displaying a list of the available word processor functions (step 285) and allowing the user to select and launch one of the functions.

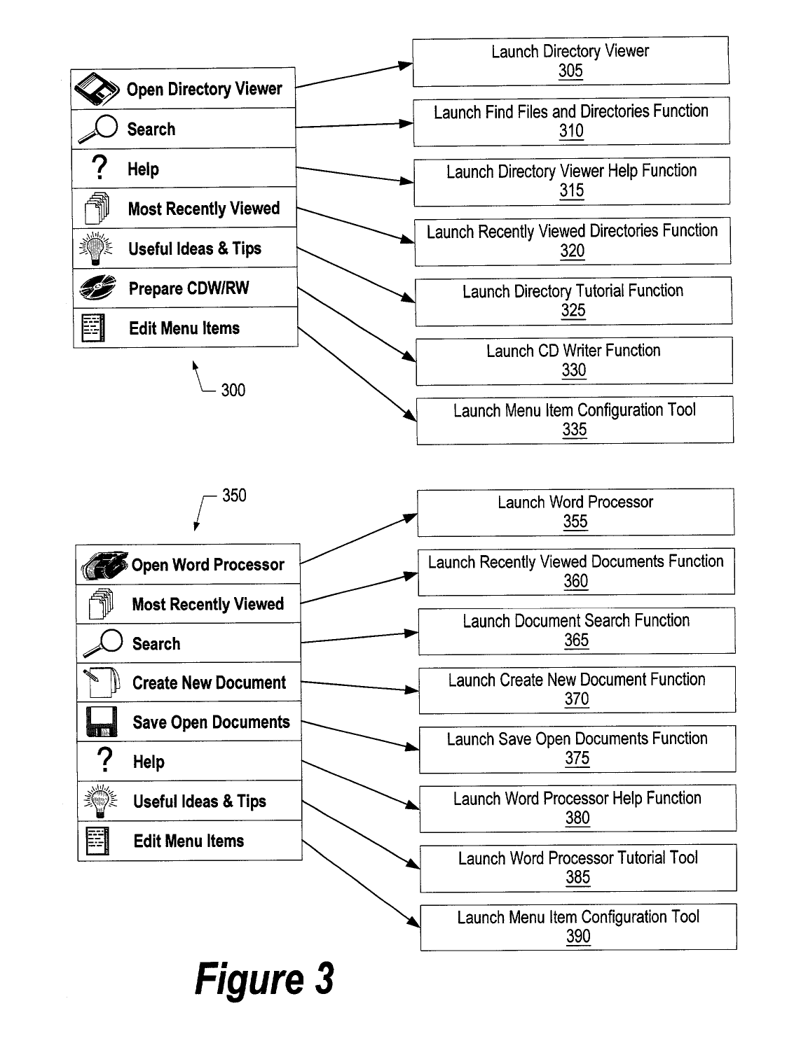

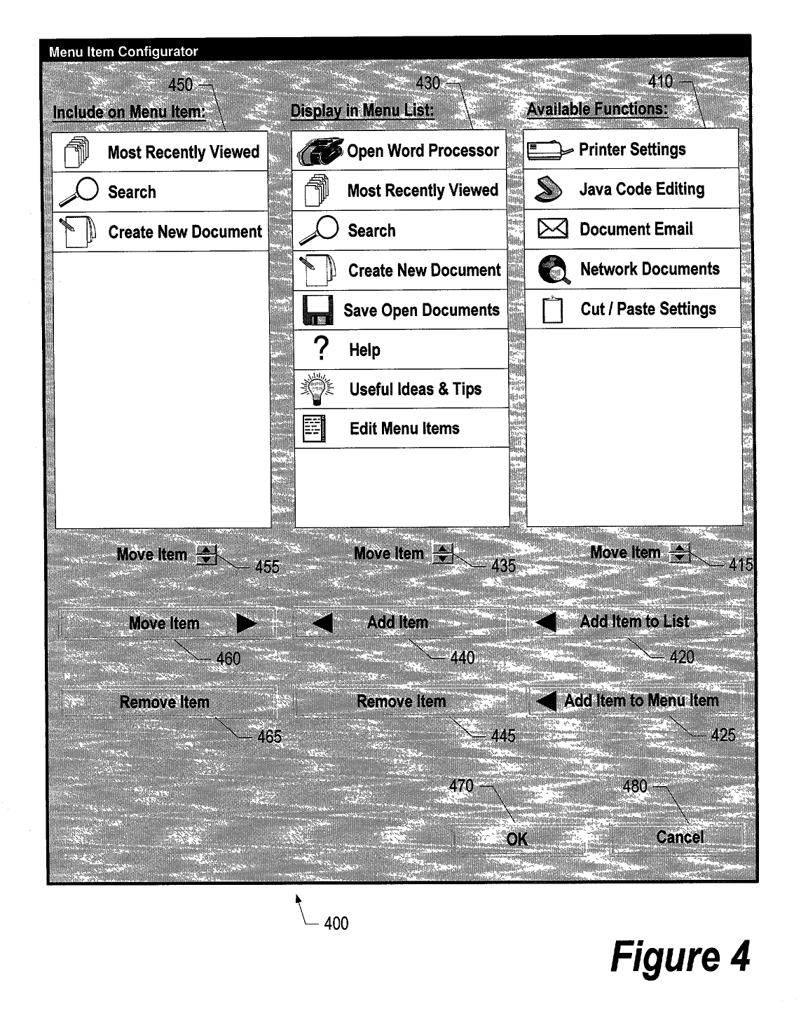

FIG. 3 is a diagram showing how various sub-menu items correspond to different functions or applications. Directory viewer sub-menu 300 includes several functions and applications that can be launched when the sub-menu is displayed. When the open directory viewer menu item is selected the system launches the directory viewer (step 305). When the search menu item is selected, the system launches the find files and directories function (step 310). When the help menu item is selected, the system launches the directory viewer help function (step 315). When the most recently viewed menu item is selected, the system launches the most recently viewed directories function (step 320). When the useful ideas and tips menu item is selected, the system launches the directory viewer tutorial function (step 325). When the prepare CDW/RW menu item is selected, the system launches the CD writer function (step 330). Finally, when the edit menu items function is selected, the system launches the menu item configuration tool (step 335, see FIG. 4) which allows the user to configure menu items by including and removing icons from menu items and including or removing functions from sub-menus corresponding to menu items.

Word processor sub-menu 350 includes several functions and applications that can be launched when the sub-menu is displayed. When the open Word processor menu item is selected the system launches the Word processor (step 355). When the most recently viewed menu item is selected, the system launches the most recently viewed documents function (step 360). When the search menu item is selected, the system launches the find documents function (step 365). When the create new document menu item is selected, the system launches the create new document function (step 370). When the save open documents menu item is selected, the system launches the save open documents function (step 375) which saves any open documents. When the help menu item is selected, the system launches the word processor help function (step 380). When the useful ideas and tips menu item is selected, the system launches the word processor tutorial function (step 385). Finally, when the edit menu items function is selected, the system launches the menu item configuration tool (step 390, see FIG. 4) which allows the user to configure menu items by including and removing icons from menu items and including or removing functions from sub-menus corresponding to menu items.

FIG. 4 is a user interface screen showing a configuration tool used to configure a given menu item. Configuration screen 400 includes three panes are used to move functions depending on where the user wants the function to appear. Available functions pane 410 shows functions that are available but do not appear in either the menu item's menu list display or on the menu item itself. Items in available functions pane 410 can be reordered by selecting a particular item and moving the selected item up or down in available functions pane 410 by using spin control 415. To add a selected function to the menu list, the user selects add item command button 420, and to add a selected function to the menu item the user selects add item command button 425.

Display in menu list pane 430 shows functions that appear when the user views a sub-menu from a menu item (by pressing the right arrow appearing on the right side of the menu item). Items in pane 430 can be reordered by selecting a particular item and moving the selected item up or down in the pane by using spin control 435. The items also appear in the order selected when the user views the corresponding sub-menu from the menu item. To add a selected function from the menu list to the menu item, the user selects add item command button 440 and the selected item is added to menu item pane 450. To remove a selected item from the menu list, the user selects remove item command button 445 and the selected item is removed from menu list pane 430 and re-added to available functions pane 410.

Display on menu item pane 450 shows functions that appear on the menu item, preferably as an icon to conserve space on the menu item. Items in pane 450 can be reordered by selecting a particular item and moving the selected item up or down in the pane by using spin control 455. The icons corresponding to the items also appear in the order selected when the user views the menu item. To move a selected function from menu item pane 450 to menu list pane 430, the user selects move item command button 460. To remove a selected item from menu item pane 450, the user selects remove item command button 465 and the selected item is removed from menu item pane 450 and re-added to available functions pane 410.

If the user wants to save changes made to the menu item's configuration, he presses OK command button 470. On the other hand, if the user wants to abort changes made to the menu item's configuration, he presses Cancel command button 480.

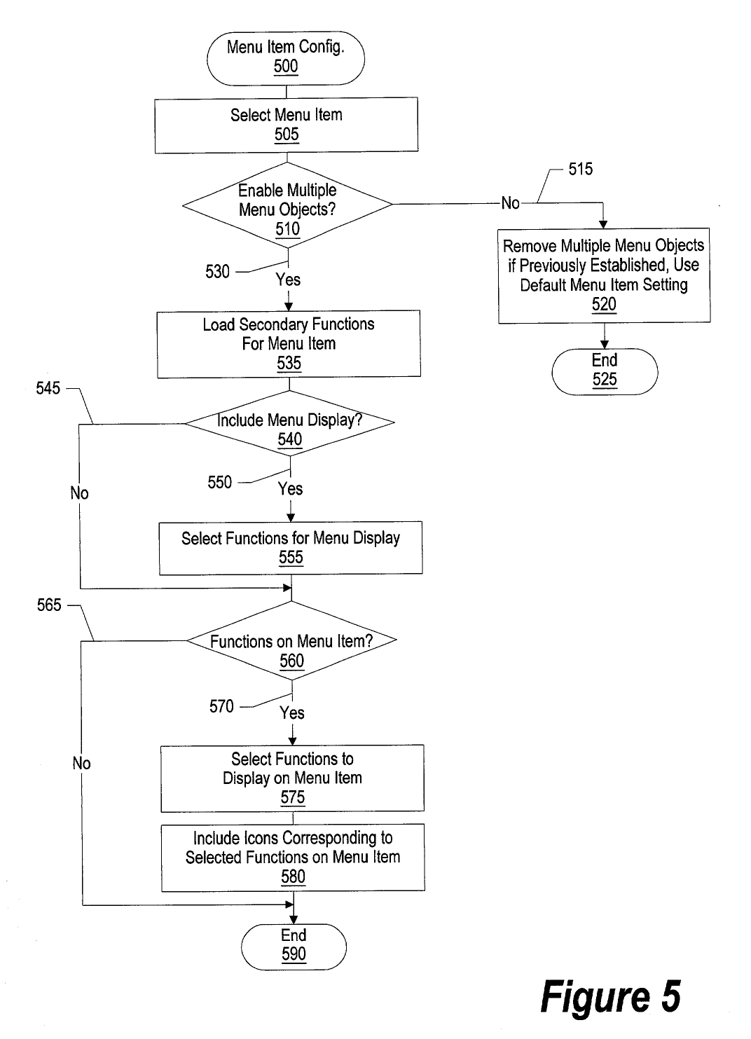

FIG. 5 is a flowchart for configuring a menu item. Processing commences at 500 whereupon the user selects a menu item from a menu display (step 505). A determination is made as to whether the user wants to enable multiple menu objects for the selected menu item (decision 510). This determination can be made by the user selecting a command control, such as a command button or an option button. If the user decides to not enable multiple menu objects for a menu item, decision 510 branches to “no” branch 515 whereupon any existing multiple menu objects that may have been previously added to the menu item are removed and the menu item's default settings are restored (step 520) and processing ends at 525.

On the other hand, if the user wishes to enable multiple menu objects, or functions, for a menu item decision 510 branches to “yes” branch 530 whereupon secondary functions are loaded for the selected menu item (step 535). In addition, the user could select additional applications or functions to load with the selected menu item. A determination is made as to whether the user wishes to include a secondary menu display with the selected menu item (decision 540). If the user does not want to include a secondary menu display, decision 540 branches to “no” branch 545 bypassing secondary menu display processing. On the other hand, if the user wishes to include a secondary menu display, decision 540 branches to “yes” branch 550 whereupon available functions are selected by the user and included in a secondary function display (step 555, see pane 430 in FIG. 4 for an example of functions selected for inclusion in a secondary function display).

A determination is made as to whether the user wants to include secondary functions on the menu item (decision 560). If the user does not want to include secondary functions on the menu item, decision 560 branches to “no” branch 565 bypassing steps used to include the secondary functions on the menu item. On the other hand, if the user wishes to include secondary functions on the menu item, decision 560 branches to “yes” branch 570 whereupon available functions are selected by the user and included (preferably as icons to conserve space) on the menu item (step 575, see pane 450 in FIG. 4 for an example of functions selected for inclusion in a secondary function display). Icons corresponding to the selected functions are included with the menu item (step 580) so that the secondary function icons will be selectable directly from the menu item. Menu item configuration processing then ends at 590.

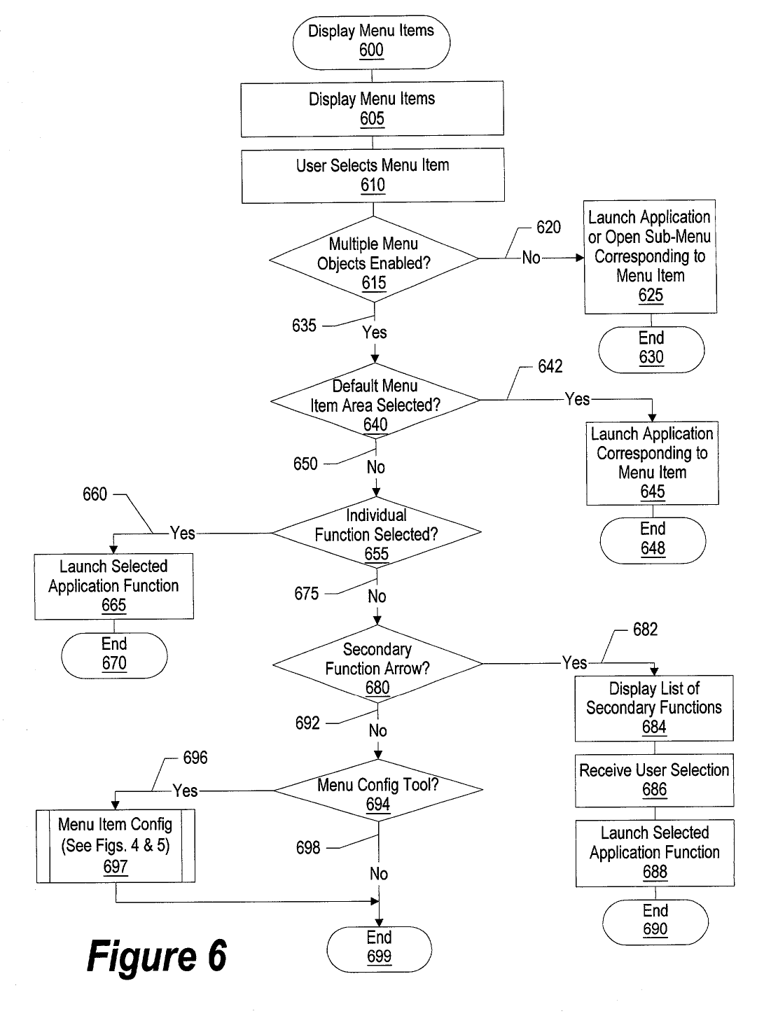

FIG. 6 is a flowchart for handling a user selection of a menu item component. Processing commences at 600 whereupon menu items are displayed to the user (step 605). Menu objects may be displayed by the user selecting any type of menu, such as a pull down menu or a “start” programs menu. The user selects one of the displayed menu items (step 610) using the keyboard or pointing device such as a mouse. A determination is made as to whether the selected menu item has multiple menu objects enabled (decision 615). If multiple menu objects have not been enabled for the selected menu item, decision 615 branches to “no” branch 620 whereupon the action corresponding to the selected menu item is performed (step 625), such as launching an application, directly setting a value, or opening a sub-menu with more selectable menu items after which processing ends at 630.

On the other hand, if multiple menu objects have been enabled for the selected menu item, decision 615 branches to “yes” branch 635. A series of determinations are made in regard to which portion of the menu item was selected by the user. A determination is made as to whether the default area on the menu item was selected (decision 640). For an example of a default area, see the left portions of menu items 200 and 240 shown in FIG. 2. Returning to FIG. 6, if the default area on the menu item was selected, decision 640 branches to “yes” branch 642 whereupon the application corresponding to the menu item is launched (step 645) and processing ends at 648.

If the default area of the menu item was not selected, decision 640 branches to “no” branch 650 and processing continues. A determination is made as to whether an individual functional icon included in the menu item was selected (decision 655). If an individual functional icon was selected, decision 655 branches to “yes” branch 660 whereupon the selected function is launched (step 665) and processing thereafter ends at 670. If an individual functional icon was not selected, decision 655 branches to “no” branch 675 and processing continues. A determination is made as to whether the secondary function arrow appearing on the menu item was selected (decision 680). For an example of a secondary function arrow, see arrows 125 and 145 on FIG. 1. Returning to FIG. 6, if the secondary function arrow was selected, decision 680 branches to “yes” branch 682. A list of secondary functions corresponding to the menu item are displayed (step 684). The user selects one of the displayed secondary functions (step 686) and the selected secondary function is launched (step 688) before processing ends at 690.

If the secondary function arrow was not selected, decision 690 branches to “no” branch 692. A determination is made as to whether the user has requested to configure the selected menu item (decision 694). If the user is requesting to configure the selected menu item, decision 694 branches to “yes” branch 696 whereupon a menu item configuration tool is launched (predefined process 697, see FIGS. 4 and 5 for further details regarding a menu item configuration tool). If the user is not requesting to configure the selected menu item, decision 694 branches to “no” branch 698. Display menu items processing ends at 699.

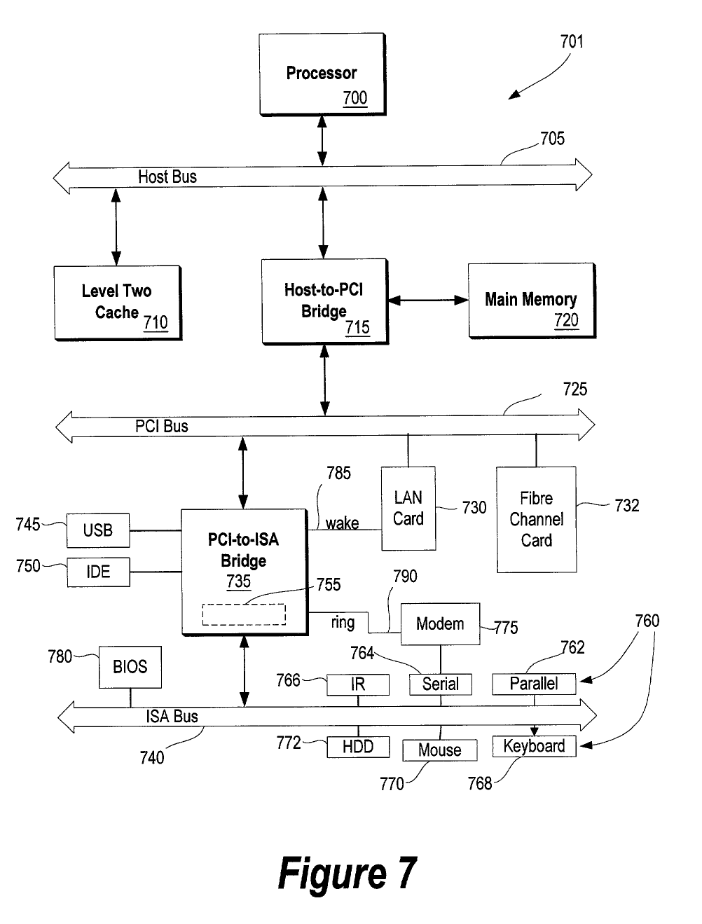

FIG. 7 illustrates information handling system 701 which is a simplified example of a computer system capable of performing the server and client operations described herein. Computer system 701 includes processor 700 which is coupled to host bus 705. A level two (L2) cache memory 710 is also coupled to the host bus 705. Host-to-PCI bridge 715 is coupled to main memory 720, includes cache memory and main memory control functions, and provides bus control to handle transfers among PCI bus 725, processor 700, L2 cache 710, main memory 720, and host bus 705. PCI bus 725 provides an interface for a variety of devices including, for example, LAN card 730. PCI-to-ISA bridge 735 provides bus control to handle transfers between PCI bus 725 and ISA bus 740, universal serial bus (USB) functionality 745, IDE device functionality 750, power management functionality 755, and can include other functional elements not shown, such as a real-time clock (RTC), DMA control, interrupt support, and system management bus support. Peripheral devices and input/output (I/O) devices can be attached to various interfaces 760 (e.g., parallel interface 762, serial interface 764, infrared (IR) interface 766, keyboard interface 768, mouse interface 770, and fixed disk (HDD) 772) coupled to ISA bus 740. Alternatively, many I/O devices can be accommodated by a super I/O controller (not shown) attached to ISA bus 740.

BIOS 780 is coupled to ISA bus 740, and incorporates the necessary processor executable code for a variety of low-level system functions and system boot functions. BIOS 780 can be stored in any computer readable medium, including magnetic storage media, optical storage media, flash memory, random access memory, read only memory, and communications media conveying signals encoding the instructions (e.g., signals from a network). In order to attach computer system 701 to another computer system to copy files over a network, LAN card 730 is coupled to PCI bus 725 and to PCI-to-ISA bridge 735. Similarly, to connect computer system 701 to an ISP to connect to the Internet using a telephone line connection, modem 775 is connected to serial port 764 and PCI-to-ISA Bridge 735.

While the computer system described in FIG. 7 is capable of executing the invention described herein, this computer system is simply one example of a computer system. Those skilled in the art will appreciate that many other computer system designs are capable of performing the invention described herein.

One of the preferred implementations of the invention is an application, namely, a set of instructions (program code) in a code module which may, for example, be resident in the random access memory of the computer. Until required by the computer, the set of instructions may be stored in another computer memory, for example, on a hard disk drive, or in removable storage such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method of providing secondary functions from a menu item graphical control, said method comprising:
including a plurality of graphical components with the menu item graphical control, each of the graphical components corresponding to a different programmed function;
displaying the menu item graphical control with the included graphical components;
receiving a selection from a user corresponding to one of the graphical components; and
invoking the programmed function corresponding the selected graphical component.

2. The method as described in claim 1 further comprising:
displaying a sub-menu of selectable programmed functions in response to the user selecting a sub-menu graphical component.

3. The method as described in claim 1 wherein at least one of the graphical components includes a graphical icon that is displayed on the menu item graphical control.

4. The method as described in claim 1 further comprising:
configuring the plurality of programmed functions using a configuration tool;
modifying the menu item graphical control to include the graphical components corresponding to the configured programmed functions; and
saving the configured plurality of programmed functions and the modified menu item graphical control.

5. The method as described in claim 1 further comprising:
configuring one or more secondary functions to include in a sub-menu;
modifying the menu item graphical control to include a sub-menu graphical component corresponding to the sub-menu;
saving the secondary functions and the modified menu item.

6. The method as described in claim 1 further comprising:
receiving a default selection corresponding to a default area of the menu item graphical control; and
invoking a default function in response to the default selection.

7. The method as described in claim 1 wherein the programmed functions include one or more application programs.

8. The method as described in claim 1 wherein the programmed functions include one or more application functions corresponding to an application program and wherein the menu item graphical control corresponds to the application program.

9. An information handling system comprising:
one or more processors;
a memory accessible by the processors;
a nonvolatile storage area accessible by the processors;
a display screen accessible by the processors;
an input device capable of a receiving input from a user corresponding to data displayed on the display screen; and
a secondary function menu item tool to include secondary functions with a menu item graphical control, the secondary function menu item tool including:
display logic for displaying a plurality of graphical components with the menu item graphical control on the display device, each of the graphical components corresponding to a different programmed function;
menu item logic for displaying the menu item graphical control with the included graphical components;
input processing logic for receiving a selection from a user corresponding to one of the graphical components; and
task scheduling logic for invoking the programmed function corresponding the selected graphical component.

10. The information handling system as described in claim 9 further comprising:
display logic for displaying a sub-menu of selectable programmed functions in response to the user selecting a sub-menu graphical component.

11. The information handling system as described in claim 9 wherein at least one of the graphical components includes a graphical icon that is displayed on the menu item graphical control.

12. The information handling system as described in claim 9 further comprising:
configuration logic for configuring the plurality of programmed functions using a configuration tool;
graphic modification logic for modifying the menu item graphical control to include the graphical components corresponding to the configured programmed functions; and
storage handling logic for saving the configured plurality of programmed functions and the modified menu item graphical control to the nonvolatile storage area.

13. A computer program product stored on a computer operable medium for providing secondary functions from a menu item graphical control, said computer program product comprising:
means for including a plurality of graphical components with the menu item graphical control, each of the graphical components corresponding to a different programmed function;
means for displaying the menu item graphical control with the included graphical components;
means for receiving a selection from a user corresponding to one of the graphical components; and
means for invoking the programmed function corresponding the selected graphical component.

14. The computer program product as described in claim 13 further comprising:
means for displaying a sub-menu of selectable programmed functions in response to the user selecting a sub-menu graphical component.

15. The computer program product as described in claim 13 wherein at least one of the graphical components includes a graphical icon that is displayed on the menu item graphical control.

16. The computer program product as described in claim 13 further comprising:
means for configuring the plurality of programmed functions using a configuration tool;
means for modifying the menu item graphical control to include the graphical components corresponding to the configured programmed functions; and
means for saving the configured plurality of programmed functions and the modified menu item graphical control.

17. The computer program product as described in claim 13 further comprising:
means for configuring a plurality of secondary functions to include in a sub-menu;
means for modifying the menu item graphical control to include a sub-menu graphical component corresponding to the sub-menu;
means for saving the plurality of secondary functions and the modified menu item.

18. The computer program product as described in claim 13 further comprising:
means for receiving a default selection corresponding to a default area of the menu item graphical control; and
means for invoking a default function in response to the default selection.

19. The computer program product as described in claim 13 wherein the programmed functions include one or more application programs.

20. The computer program product as described in claim 13 wherein the programmed functions include one or more application functions corresponding to an application program and wherein the menu item graphical control corresponds to the application program

21. A method of providing secondary functions from a menu item graphical control, said method comprising:
configuring one or more secondary functions to include in a sub-menu;
modifying the menu item graphical control to include a sub-menu graphical component corresponding to the sub-menu, wherein the menu item graphical control further includes one or more graphical components corresponding to one or more programmed functions; and
displaying the sub-menu in response to a user selecting the sub-menu graphical component.

22. A method of providing secondary functions from a menu item graphical control, said method comprising:
configuring a plurality of programmed functions using a configuration tool;
identifying a plurality of graphical components for each of the programmed functions;
modifying the menu item graphical control to include the graphical components corresponding to the configured programmed functions;
displaying the menu item graphical control with the included graphical components;
receiving a selection from a user corresponding to one of the graphical components; and
invoking the programmed function corresponding the selected graphical component.

23. An information handling system comprising: one or more processors;
a memory accessible by the processors;
a nonvolatile storage area accessible by the processors;
a display screen accessible by the processors; an input device capable of a receiving input from a user corresponding to data displayed on the display screen; and
a secondary function menu item tool to include secondary functions with a menu item graphical control, the secondary function menu item tool including:
means for configuring one or more secondary functions to include in a sub-menu;
means for modifying the menu item graphical control to include a sub-menu graphical component corresponding to the sub-menu, wherein the menu item graphical control further includes one or more graphical components corresponding to one or more programmed functions; and
means for displaying the sub-menu in response to a user selecting the sub-menu graphical component.

24. An information handling system comprising: one or more processors;
a memory accessible by the processors;
a nonvolatile storage area accessible by the processors;
a display screen accessible by the processors;
an input device capable of a receiving input from a user corresponding to data displayed on the display screen; and
a secondary function menu item tool to include secondary functions with a menu item graphical control, the secondary function menu item tool including:
means for configuring a plurality of programmed functions using a configuration tool;
means for identifying a plurality of graphical components for each of the programmed functions;
means for modifying the menu item graphical control to include the graphical components corresponding to the configured programmed functions;
means for displaying the menu item graphical control with the included graphical components;
means for receiving a selection from a user corresponding to one of the graphical components; and
means for invoking the programmed function corresponding the selected graphical component.

25. A computer program product stored on a computer operable medium for providing secondary functions from a menu item graphical control, said computer program product comprising:
means for configuring one or more secondary functions to include in a sub-menu;
means for modifying the menu item graphical control to include a sub-menu graphical component corresponding to the sub-menu, wherein the menu item graphical control further includes one or more graphical components corresponding to one or more programmed functions; and
means for displaying the sub-menu in response to a user selecting the sub-menu graphical component.

26. A computer program product stored on a computer operable medium for providing secondary functions from a menu item graphical control, said computer program product comprising:
means for configuring a plurality of programmed functions using a configuration tool;
means for identifying a plurality of graphical components for each of the programmed functions;
means for modifying the menu item graphical control to include the graphical components corresponding to the configured programmed functions;
means for displaying the menu item graphical control with the included graphical components;
means for receiving a selection from a user corresponding to one of the graphical components; and
means for invoking the programmed function corresponding the selected graphical component.
